(19) United States
(12) Patent Application Publication
(10) Pub. No.: US 2006/0085425 A1
(43) Pub. Date: Apr. 20, 2006

(54) Cluster spanning command routing

(75) Inventors: John D. Lauer, Tucson, AZ (US); Brian S. McCain, Tucson, AZ (US); Amy L. Therrien, Tucson, AZ (US); Yan Xu, Tucson, AZ (US)

Correspondence Address: SCULLY, SCOTT, MURPHY, & PRESSER, 400 GARDEN CITY PL, GARDEN CITY, NY, 11530, US

(73) Assignee: INTERNATIONAL BUSINESS MACHINES CORPORATION, ARMONK, NY (US)

(21) Appl. No.: 10/965,983

(22) Filed: Oct. 15, 2004

(51) Int. Cl. G06F 17/30

(52) U.S. Cl. 707/10

(57) ABSTRACT

A technique for enabling a client to access the resources of different servers without having specific knowledge of which server has which resources. The client generates multiple copies of a request that identifies an operation to be performed, such as a copy type operation. The client sends a copy of the request to each server. The server determines whether the operation requires access to the server's associated data storage resource. If it does, the server accesses the resource to perform the operation, and sends a corresponding response to the client. Different servers can work on different operations specified in a request. The client receives and merges the responses from the servers. During a failure of one cluster in a multi-cluster system, the surviving cluster can process a request using the resources owned by the failed cluster.

### BACKGROUND OF THE INVENTION

1. Field of the Invention

The invention relates generally to the field of data storage in computer systems and, more specifically, to a technique for enabling a client to access the data storage resources of different servers without having specific knowledge of which server owns which resources.

2. Description of the Related Art

Computer storage devices such as storage servers have high-capacity disk arrays to backup data from external host systems, such as host servers. For example, a large corporation or other enterprise may have a network of servers that each store data for a number of workstations used by individual employees. Periodically, the data on the host servers is backed up to the high-capacity storage server to avoid data loss if the host servers malfunction. A storage server may also backup data from another storage server, such as at a remote site. Furthermore, it is known to employ redundant server clusters in a data storage system to provide additional safeguards against data loss. The IBM Enterprise Storage Server (ESS) is an example of such a data storage system.

A problem occurs in a client-server environment where requests are sent from the client to multiple servers. The requests include operations to be performed at the servers using the server's resources. Each server owns a specific set of resources and is responsible for the work performed on those resources. In one approach, the client provides separate requests to each server according to the resources needed. The client sends a separate request to each server involving that server's resources, such as a request to perform copy operations among different volumes, and waits for a response from each server. However, this requires the client to know which servers owns which resources, and results in reduced performance since multiple, different requests are generated. Moreover, difficulties arise when the client requires access to the resources of a failed server whose work has been taken over by another server, such as in a dual cluster system, when the client does not know of the failure.

### BRIEF SUMMARY OF THE INVENTION

To overcome these and other deficiencies in the prior art, the present invention describes a technique for enabling a client to perform operations involving the resources of different servers without having specific knowledge of which server has which resources.

In one aspect of the invention, at least one program storage device tangibly embodies a program of instructions executable by at least one processor to perform a method at a server for accessing an associated data storage resource. The method includes receiving a copy of a request, sent from a client, that identifies at least one operation to be performed, processing the request to determine whether the at least one operation requires access to the associated data storage resource, and accessing the associated data storage resource to perform the at least one operation if the at least one operation requires access to the associated data storage resource.

In another aspect of the invention, a method is provided for accessing a plurality of data storage resources at a plurality of servers, wherein each server is associated with at least one of the plurality of data storage resources. The method includes receiving, at each server, a copy of a request from a client that identifies at least one operation to be performed, at each server, processing the request to determine whether the at least one operation requires access to the associated data storage resource, and at each server for which the at least one operation requires access to the associated data storage resource, accessing the associated data storage resource to perform the at least one operation

In a further aspect of the invention, at least one program storage device tangibly embodies a program of instructions executable by a machine to perform a method at a client for communicating with a plurality of servers, wherein each server has an associated data storage resource. The method includes generating multiple copies of a request that identifies at least one operation to be performed, sending a copy of the request to each server, wherein the servers access the associated data storage resources, and at least one of the servers accesses it data storage resource to perform the at least one operation, and sends a response to the client indicating that the at least one operation has been performed, and receiving the response.

Related computer-implemented methods, systems and program storage devises may be provided.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates a client communicating with a data storage system having dual server clusters, according to the invention; and

FIG. 2 illustrates a method where a client communicates with a dual-cluster data storage system.

### DETAILED DESCRIPTION OF THE INVENTION

The present invention describes a technique for enabling a client to access the resources of different servers without having specific knowledge of which server owns which resources. The invention solves the problem at the server level as opposed to the client level so that the client does not need to be concerned with which resources are owned by which servers. In particular, the invention works by replicating a request, and providing it to all servers involved instead of breaking up a request into smaller requests which are tailored for each server. Upon the receipt of a request, the server only acts upon those resources identified in the request for which it is the owner. If the server has no work to do, e.g., its does not own any of the identified resources, it sends an empty response immediately to the client.

Any server that has work to do performs the work by accessing its resources, and sends a corresponding response indicating the work performed to the client. The client then merges all responses from the different servers to determine that the request has been fulfilled. The invention is also applicable to the case where one server takes over the responsibilities of another, paired server, such as in a dual-cluster system. In this case, the two paired servers communicate with one another so that one server is informed when the other server fails, end each server knows the other's resources. When one server fails and takes over the other server's work, the surviving server will execute more of the actions in the client's request because it owns more of the resources. Advantageously, performance is improved at the client side because the client can invoke a single request that impacts resources on several different servers.

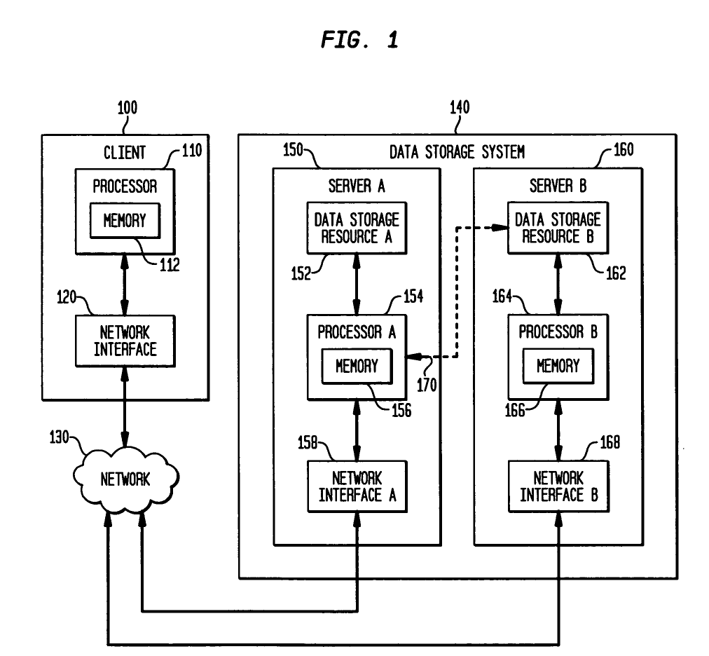

FIG. 1 illustrates a client communicating with a data storage system having dual storage clusters, according to the invention. The client host 100 includes a processor 110, memory 112 and a network interface 120 such as a network interface card. The client host 100 may be general-purpose computer, workstation, server, portable device such as PDAs, or other computer device, for instance. The network interface 120 allows the client host 100 to communicate via a network 130 with a number of different server hosts, such as server A 150 and server B 160 in a data storage system 140. The servers 150, 160 are respective server clusters in a dual-cluster device such as the IBM ESS. In this case, if one of the servers fails, the other server takes over the failed server's responsibilities. However it is also possible for the servers 150 and 160 to be independent devices that do not provide redundancy, or that are operatively coupled to provide redundancy in the event of failure. Furthermore, the client 100 may communicate with additional servers, not shown, to perform operations involving their resources.

Each of the servers 150, 160 includes a network interface 158, 168 such as a network interface card for communicating with the client host 100, such as to receive requests from the client host 100 and to provide responses to the client host 100. Note that these requests and response may be provided using any type of network communication protocol. A processor 154, 164 with memory 156, 166 coordinates the communications via the network interfaces 158, 168 and handles reading and writing of data from and to respective data storage resources 152, 162. In particular, the data storage resources 152, 162 may comprise arrays of disks or other storage media. In the dual-cluster data storage system 140, each server cluster 150, 160 owns particular storage resources. In normal operations, with both clusters 150, 160 functional, each server cluster has write access only to the storage resources it owns, but has read access to all storage resources in the device 140. In the event of a cluster failure, the surviving cluster assumes ownership of the storage resources of the failed cluster. For example, the dashed line 170 indicates that server A 150 can assume ownership of the data storage resource B 162 when server B 162 fails.

Furthermore, the data storage resources 152, 162 may be arranged in logical subsystems (LSSs), which are comprised of volumes. The LSS is a topological construct that includes a group of logical devices such as logical volumes, which represent some amount of usable space, most likely spread across multiple physical disks. For example, a logical volume in a RAID array may be spread over different tracks in the disks in the array. Each cluster 150, 160 may therefore own a number of logical volumes as its data storage resource. In the normal, dual cluster mode, when both clusters 150, 160 are functional, ownership of the volumes or LSSs can be evenly divided between the clusters. When one of the clusters 150 or 160 fails, the data storage system 140 will operate in a fail safe, single cluster mode, by assigning ownership of all volumes or LSSs to the surviving cluster. The fail-safe mode reduces the chance of data loss and downtime. Moreover, as mentioned, the invention may also be carried out in servers 150, 160 that are independent, and do not have the ability to access each other's data storage resources.

The general operation and configuration of the memories 112, 156 and 166, processors 110, 154 and 164, and network interfaces 120, 158 and 168 is well known in the art and is therefore not described in detail. The functionality described herein can be achieved by configuring the hosts 100, 150 and 160 with appropriate instructions, e.g., software, firmware or micro code, in the memories 112, 156 and 166, for execution by the respective processors 110, 154 and 164. The memories 112, 156 and 166 may therefore be considered to be program storage devices for carrying out a method for achieving the functionality described herein.

Appropriate user interfaces may also be provided to allow a user to interact with the client 100 and servers 150 and 160 such as by entering commands and viewing status information.

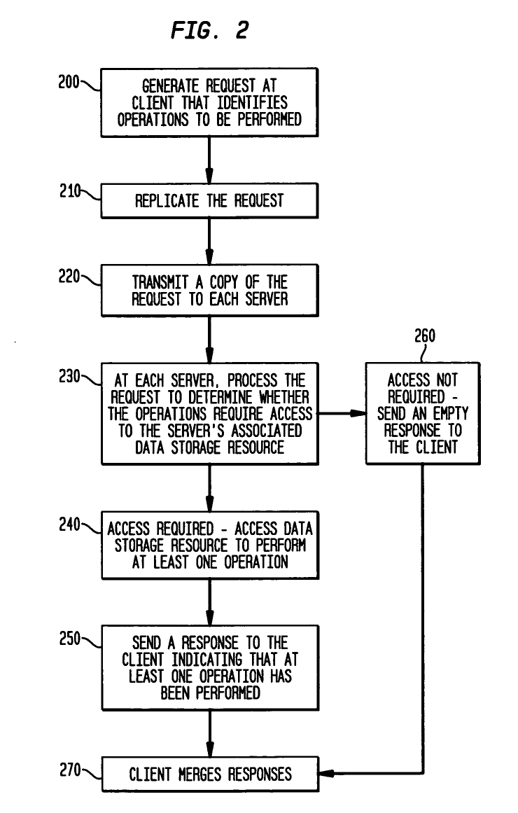

FIG. 2 illustrates a method where a client communicates with a dual-cluster data storage system. At block 200, the client generates a request that identifies operations to be performed by one or more servers. For example, it may be desired to perform various copy type operations such as identifying two or more volumes and making one volume a copy of the other volume. In this case, the operations include creating the copy relationship between one or more volumes, modifying the copy relationship, and removing the relationship after the task has been completed. To achieve this, the client creates a request to copy the contents of volume A to volume B, where volume A is a resource owned by the server that the client sends the request to. Note that Volume B could be on a different server than Volume A because the copy operation is driven by the source volume. The request need not be sent to the server that owns Volume B since the source volume is the master of the copy, and it is the owner of the request. Functional micro code can be provided at the server that owns Volume A to handle talking to the server that owns Volume B via a communication channel such as a fibre channel link.

At block 210, the client replicates the request, for example, to provide two copies of the request, one for each of the clusters 150 and 160. At block 220, the client transmits a separate copy of the request to each server 150 and 160. The client only has to know which group of servers to send the request to. It may do this by using a unique serial number that identifies each data storage system, for example. This serial number is provided in each request. Once the client knows the serial number, code at the client handles sending the request to both servers in the specified data storage system. The request need not be transmitted to other servers or data storage systems with which the client may have the ability to communicate. In this manner, it is not necessary for the client to know which server 150, 160 owns the data storage resource or resources that are involved in carrying out the request.

At block 230, each server that receives a copy of the request processes it to determine whether the operations identified in the request require access to the server's associated storage resource. This may involve, e.g., comparing identifiers of the volumes involved in a requested copy operation with a list of volumes that the server owns. The identifiers of the involved volumes may be included in the request, for instance. If access is not required (block 260), the server sends an empty response to the client. If access is required (block 240), the server accesses its data storage resource to perform at least one operation, and (block 250) sends a response to the client indicating that the at least one operation has been performed. It is possible for a single server to perform all of the necessary operations identified in a request if access to the data storage resource of another server is not required. Or, each server may act on part of the request.

A request can be a complicated, involving more than one operation. For example, a request may be to copy volume A to volume B, volume C to volume D, and volume E to volume F. Assume a first server owns volumes A and B, and a second server, within the same data storage system, owns resources C through F. At the client, the request is duplicated and sent to both servers. The first server looks through the entire request and sees it can perform the copy from volume A to B. The second server looks through the same request and sees that it can perform the copy from volume C to D, and from volume E to F. Both servers thus can do part of the work involved in a request and send a corresponding response back to the client when the work is completed. For example, the first server can send a response indicating that it has performed the copy from volume A to B, and the second server can send a response indicating that it has performed the copy from volume C to D, and from volume E to F. The two responses can then be merged at the client (block 270) to enable the client to ascertain that the entire request has been fulfilled.

The invention thus alleviates the need for the client to prepare a first request for the first server involving the copy from volume A to B, and a separate, second request for the second server involving the copy from volume C to D, and from volume E to F.

While the invention has been illustrated in terms of a dual cluster storage server, it is applicable as well to multi-cluster systems having higher levels of redundancy, as well as to individual servers that are operatively connected or independent.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. At least one program storage device tangibly embodying a program of instructions executable by at least one processor to perform a method at a server for accessing an associated data storage resource, the method comprising:
receiving a copy of a request, sent from a client, that identifies at least one operation to be performed;
processing the request to determine whether the at least one operation requires access to the associated data storage resource; and
accessing the associated data storage resource to perform the at least one operation if the at least one operation requires access to the associated data storage resource.

2. The at least one program storage device of claim 1, wherein the method further comprises:
after performing the at least one operation, sending a response to the client indicating that the at least one operation has been performed.

3. The at least one program storage device of claim 1, wherein the method further comprises:
sending an empty response to the client if the at least one operation does not require access to the associated data storage resource.

4. The at least one program storage device of claim 1, wherein the server is a first server in a data storage system which also includes a second server having an associated data storage resource, and the second server receives a copy of the request, the method further comprising:
processing the request, at the first server, to determine whether the at least one operation requires access to the associated data storage resource of the second server; and
if the at least one operation requires access to the associated data storage resource of the second server, and the second server fails, accessing the associated data storage resource of the second server to perform the at least one operation.

5. The at least one program storage device of claim 4, wherein:
the first and second servers are respective server clusters in the data storage system.

6. The at least one program storage device of claim 1, wherein:
the request identifies at least one volume on which the at least one operation is to be performed; and
the determining whether the at least one operation requires access to the associated data storage resource comprises determining whether the server owns the at least one volume.

7. The at least one program storage device of claim 6, wherein:
the at least one operation comprises a copy operation involving the at least one volume.

8. A method for accessing a plurality of data storage resources at a plurality of servers, wherein each server is associated with at least one of the plurality of data storage resources, comprising:
receiving, at each server, a copy of a request from a client that identifies at least one operation to be performed;
at each server, processing the request to determine whether the at least one operation requires access to the associated data storage resource; and
at each server for which the at least one operation requires access to the associated data storage resource, accessing the associated data storage resource to perform the at least one operation.

9. The method of claim 8, further comprising:
at each server for which the at least one operation requires access to the associated data storage resource, after performing the at least one operation, sending a response to the client indicating that the at least one operation has been performed.

10. The method of claim 8, further comprising:
at each of the servers for which the at least one operation does not require access to the associated data storage resource, sending an empty response to the client.

11. The method of claim 8, wherein:
if a first of the servers fails, a second of the servers assumes ownership of the associated storage resources of the first of the servers; and
if it is determined, at the second of the servers, that the at least one operation requires access to the associated data storage resource of the first of the servers, and the first of the servers has failed, the second of the servers accesses the associated data storage resource of the first of the servers to perform the at least one operation.

12. The method of claim 11, wherein:
the first and second servers are respective server clusters in a data storage system.

13. The method of claim 8, wherein:
the request identifies at least one volume on which the at least one operation is to be performed; and
at each server, the determining whether the at least one operation requires access to the associated data storage resource comprises determining whether the server owns the at least one volume.

14. The method of claim 8, wherein:
the request identifies multiple operations to be performed; and
different ones of the servers access their associated data storage resource to perform different ones of the operations.

15. At least one program storage device tangibly embodying a program of instructions executable by a machine to perform a method at a client for communicating with a plurality of servers, wherein each server has an associated data storage resource, the method comprising:
generating multiple copies of a request that identifies at least one operation to be performed;
sending a copy of the request to each server, wherein the servers access their associated data storage resources, and at least one of the servers accesses its data storage resource to perform the at least one operation, and sends a response to the client indicating that the at least one operation has been performed; and
receiving the response.

16. The at least one program storage device of claim 15, wherein:
each server processes the request to determine whether the at least one operation requires access to the associated data storage resource.

17. The at least one program storage device of claim 15, wherein:
the servers are respective server clusters in a data storage system.

18. The at least one program storage device of claim 15, wherein:
the request identifies at least one volume on which the at least one operation is to be performed; and
the at least one of the servers determines whether it requires access to its associated data storage resource by determining whether it owns the at least one volume.

19. The at least one program storage device of claim 18, wherein:
the at least one operation comprises a copy operation involving the at least one volume.

20. The at least one program storage device of claim 18, further comprising:
merging multiple responses received from the servers.
